(19) United States
(12) Patent Application Publication
(10) Pub. No.: US 2020/0249763 A1
(43) Pub. Date: Aug. 6, 2020

(54) ELECTRONIC DEVICE, CONTROL METHOD, AND RECORDING MEDIUM

(71) Applicant: CASIO COMPUTER CO., LTD., Tokyo (JP)

(72) Inventor: Shinichi MORITANI, Kawasaki-shi (JP)

(73) Assignee: CASIO COMPUTER CO., LTD., Tokyo (JP)

(21) Appl. No.: 16/776,452

(22) Filed: Jan. 29, 2020

(30) Foreign Application Priority Data
Feb. 5, 2019 (JP) 2019-018538

(51) Int. Cl. G06F 3/01; G06F 3/0346; G06F 3/0481; G06F 3/0482

(52) U.S. Cl. CPC G06F 3/017; G06F 3/0482; G06F 3/04817; G06F 3/0346

(57) ABSTRACT

An electronic device includes a sensor that acquires sensing data and a processor. The processor (i) determines, based on first sensing data acquired by the sensor, whether the electronic device is in a first posture state or not, (ii) specifies a level of a second posture state of the electronic device among a plurality of levels, based on second sensing data that is acquired by the sensor after the processor determines whether the electronic device is in the first posture state, and (iii) outputs a control signal based on the specified level.

### CROSS REFERENCE TO RELATED APPLICATION

This application is based upon and claims the benefit of priority under 35 USC 119 of Japanese Patent Application No. 2019-018538 filed on Feb. 5, 2019, the entire disclosure of which, including the description, claims, drawings and abstract, is incorporated herein by reference in its entirety.

### BACKGROUND OF THE INVENTION

### 1. Field of the Invention

The present invention relates to an electronic device, a control method, and a recording medium.

### 2. Description of Related Art

As described in JP2012-256099A, an information processing terminal is conventionally known which recognizes a gesture input when made on a touch panel, and executes processing concerning a predetermined control operation associated with the recognized gesture.

### SUMMARY OF THE INVENTION

To achieve at least one of the abovementioned objects, according to an aspect of the present invention, an electronic device includes:

a sensor that acquires sensing data; and

a processor,

wherein the processor

determines, based on first sensing data acquired by the sensor, whether the electronic device is in a first posture state or not,

specifies a level of a second posture state of the electronic device among a plurality of levels, based on second sensing data that is acquired by the sensor after the processor determines whether the electronic device is in the first posture state, and

outputs a control signal based on the specified level.

According to another aspect of the present invention, a control method for an electronic device includes:

a determining step of determining, based on first sensing data, whether the electronic device is in a first posture state or not,

a specifying step of specifying a level of a second posture state of the electronic device among a plurality of levels, based on second sensing data that is acquired after determining whether the electronic device is in the first posture state, and

an outputting step of outputting a control signal based on the specified level.

According to still another aspect of the present invention, a recording medium has a program readable by a computer of an electronic device stored therein, causing the computer to function as:

a determinator that determines, based on first sensing data, whether the electronic device is in a first posture state or not;

a specifier that specifies a level of a second posture state of the electronic device among a plurality of levels, based on second sensing data that is acquired after the determinator determines whether the electronic device is in the first posture state; and

an outputting unit that outputs a control signal based on the specified level.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram showing a functional configuration of an electronic device of a first embodiment.

FIG. 2 is a diagram showing a conversion table to be used in the electronic device of the first embodiment.

FIG. 3 is a flowchart showing light emission control processing executed by the electronic device of the first embodiment.

FIG. 4A is a diagram showing an example of a light emission mode of a display of the electronic device when the light emission control processing is executed, and showing the rotation angle of the electronic device when the color of emitted light is yellow.

FIG. 4B is a diagram showing an example of a light emission mode of the display of the electronic device when the light emission control processing is executed, and showing the rotation angle of the electronic device when the color of emitted light is yellow green.

FIG. 4C is a diagram showing an example of a light emission mode of the display of the electronic device when the light emission control processing is executed, and showing the rotation angle of the electronic device when the color of emitted light is green.

FIG. 4D is a diagram showing an example of a light emission mode of the display of the electronic device when the light emission control processing is executed, and showing the rotation angle of the electronic device when the color of emitted light is blue green.

FIG. 4E is a diagram showing an example of a light emission mode of the display of the electronic device when the light emission control processing is executed, and showing the rotation angle of the electronic device when the color of emitted light is greenish blue.

FIG. 4F is a diagram showing an example of a light emission mode of the display of the electronic device when the light emission control processing is executed, and showing the rotation angle of the electronic device when the color of emitted light is blue.

FIG. 4G is a diagram showing an example of a light emission mode of the display of the electronic device when the light emission control processing is executed, and showing the rotation angle of the electronic device when the color of emitted light is violet.

FIG. 4H is a diagram showing an example of a light emission mode of the display of the electronic device when the light emission control processing is executed, and showing the rotation angle of the electronic device when the color of emitted light is purple.

FIG. 4I is a diagram showing an example of a light emission mode of the display of the electronic device when the light emission control processing is executed, and showing the rotation angle of the electronic device when the color of emitted light is red purple.

FIG. 4J is a diagram showing an example of a light emission mode of the display of the electronic device when the light emission control processing is executed, and showing the rotation angle of the electronic device when the color of emitted light is red.

FIG. 4K is a diagram showing an example of a light emission mode of the display of the electronic device when the light emission control processing is executed, and showing the rotation angle of the electronic device when the color of emitted light is reddish orange.

FIG. 4L is a diagram showing an example of a light emission mode of the display of the electronic device when the light emission control processing is executed, and showing the rotation angle of the electronic device when the color of emitted light is yellowish orange.

FIG. 5 is a diagram showing a conversion table to be used in an electronic device of a second embodiment.

FIG. 6 is a flowchart showing display control processing executed by the electronic device of the second embodiment.

FIG. 7A is a diagram showing an example of a display mode when the display control processing is executed, and showing the rotation angle of the electronic device when an indication of facial expression is an indication of No emotional expression.

FIG. 7B is a diagram showing an example of a display mode when the display control processing is executed, and showing the rotation angle of the electronic device when an indication of facial expression is an indication of slight smile.

FIG. 7C is a diagram showing an example of a display mode when the display control processing is executed, and showing the rotation angle of the electronic device when an indication of facial expression is an indication of smiley face.

FIG. 7D is a diagram showing an example of a display mode when the display control processing is executed, and showing the rotation angle of the electronic device when an indication of facial expression is an indication of smiley face (with small animation).

FIG. 7E is a diagram showing an example of a display mode when the display control processing is executed, and showing the rotation angle of the electronic device when an indication of facial expression is an indication of smiley face (with big animation).

FIG. 7F is a diagram showing an example of a display mode when the display control processing is executed, and showing the rotation angle of the electronic device when an indication of facial expression is an indication of slight sadness.

FIG. 7G is a diagram showing an example of a display mode when the display control processing is executed, and showing the rotation angle of the electronic device when an indication of facial expression is an indication of sad face.

FIG. 7H is a diagram showing an example of a display mode when the display control processing is executed, and showing the rotation angle of the electronic device when an indication of facial expression is an indication of sad face (with small animation).

FIG. 7I is a diagram showing an example of a display mode when the display control processing is executed, and showing the rotation angle of the electronic device when an indication of facial expression is an indication of sad face (with big animation).

FIG. 8 is a flowchart showing display control processing executed by an electronic device of a third embodiment.

FIG. 9 is a diagram showing a conversion table to be used in the electronic device of the third embodiment.

FIG. 10 is a flowchart showing display control processing executed by a cooperation between an electronic device of a fourth embodiment and a server that distributes video content.

FIG. 11 is a representative diagram showing an outline when the display control processing of the fourth embodiment is executed.

FIG. 12 is a block diagram showing a functional configuration of an electronic device of a fifth embodiment.

FIG. 13 is a diagram showing a conversion table to be used in the electronic device of the fifth embodiment.

FIG. 14 is a flowchart showing alarm notification control processing executed by the electronic device of the fifth embodiment.

FIG. 15 is a diagram showing a luminance conversion table to be used in an electronic device of a sixth embodiment.

FIG. 16 is a flowchart showing illumination device control processing executed by the electronic device of the sixth embodiment.

FIG. 17 is a flowchart showing audio player control processing executed by electronic device of a seventh embodiment.

FIG. 18A is a diagram showing a display example of a first control menu in the seventh embodiment.

FIG. 18B is a diagram showing a display example of a second control menu in the seventh embodiment.

### DETAILED DESCRIPTION OF THE PREFERRED EMBODIMENT

Hereinafter, embodiments according to the present invention will be described in detail with reference to the attached drawings. The present invention is not limited to the illustrated examples.

### First Embodiment

### Configuration of Electronic Device 1

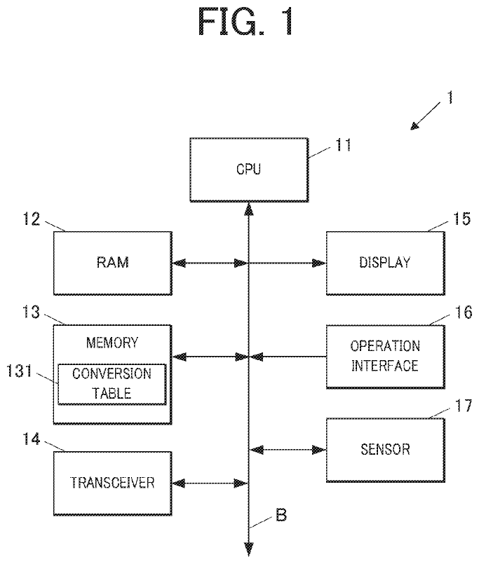

First, a functional configuration of an electronic device 1 of the first embodiment will be described with reference to FIG. 1.

FIG. 1 is a block diagram showing the functional configuration of the electronic device 1. The electronic device 1 will be described hereinafter as being a smartphone, but is not limited to this, and may be a mobile phone, tablet terminal, or the like.

The electronic device 1 is configured to include a CPU (central processing unit) 11, a random access memory (RAM) 12, a memory 13, a transceiver 14, a display 15, an operation interface 16, and a sensor 17. The respective components of the electronic device 1 are connected via a bus B.

The CPU 11 controls the respective components of the electronic device 1. The CPU 11 is a processor that reads out a designated program among system programs and application programs stored in the memory 13 for expansion to the RAM 12, and executes various types of processing in accordance with a cooperation with the program.

The RAM 12 is a volatile memory, and forms a work area that temporarily stores various types of data and programs.

The memory 13 is composed of a flash memory, an electrically erasable programmable ROM (EEPROM), or the like, for example. System programs and application programs to be executed by the CPU 11, data (for example, a conversion table 131) necessary for execution of these programs, and the like are stored in the memory 13.

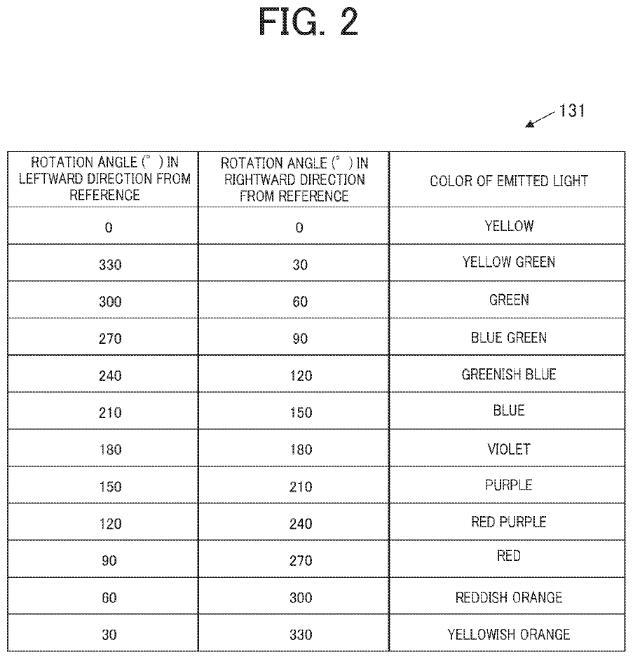

FIG. 2 is a diagram showing the conversion table 131.

As shown in FIG. 2, in the conversion table 131, information about the item of “rotation angle in leftward direction from reference”, information about the item of “rotation angle in rightward direction from reference”, and information about the item of “color of emitted light” are associated with each other, and information about the item of “rotation angle in leftward direction from reference” or information about the item of “rotation angle in rightward direction from reference” can be converted into information about the item of “color of emitted light”. For example, in a case where information about the item of “rotation angle in leftward direction from reference” is 270° or in a case where information about the item of “rotation angle in rightward direction from reference” is 90°, the information is converted into “blue green” which is information about the item of “color of emitted light”. Herein, the reference indicates, for example, a state in which the electronic device 1 is placed on the table to be inclined horizontally, and kept at still for a predetermined time. The rotation angle means a rotation angle when the electronic device 1 is rotated around the direction of gravity, the leftward direction means the counterclockwise direction, and the rightward direction means the clockwise direction. The color of emitted light means a display color of a screen of the display 15. Each piece of information about the item of “color of emitted light” is in conformity with an arrangement rule of a hue circle (arrangement rule of a plurality of colors (hue symbol and hue number)).

The transceiver 14 is composed of an antenna, a modulation/demodulation circuit, a signal processing circuit, and the like, for example. The transceiver 14 transmits/receives information to/from a base station, an access point, or the like connected to a communication network using radio waves to communicate with a device on the communication network.

The display (light emitter) 15 is composed of a liquid crystal display (LCD), an electro luminescence (EL) display, or the like, and performs various displays in accordance with display information instructed from the CPU 11.

The operation interface 16 includes a touch panel, for example, to receive a touch input made by a user, and output the operation information to the CPU 11.

The touch panel is formed integrally with the display 15, and detects XY coordinates of a point of contact on the display 15 made by the user in accordance with various systems such as a capacitive system, a resistive film system, and an ultrasonic surface acoustic wave system, for example. The touch panel then outputs a position signal related to the XY coordinates of the point of contact to the CPU 11.

The sensor 17 is configured to include a motion sensor capable of sensing the direction and posture of the electronic device 1, such as a geomagnetic sensor, gyro sensor, or three axis acceleration sensor.

### Light Emission Control Processing

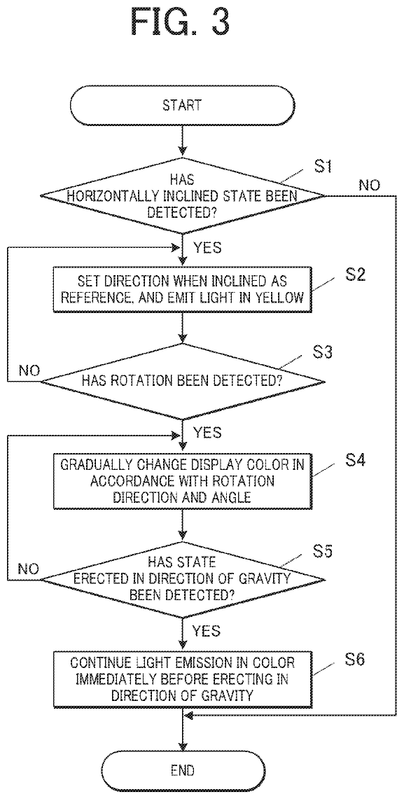

Light emission control processing executed in the electronic device 1 will be described with reference to FIG. 3. FIG. 3 is a flowchart showing light emission control processing.

First, the CPU 11 of the electronic device 1 determines whether the state in which the electronic device 1 is inclined horizontally has been detected on the basis of sensing data acquired from the sensor 17 (step S1).

In a case where it is determined in step S1 that the state in which the electronic device 1 is inclined horizontally has not been detected (NO in step S1), the CPU 11 terminates the light emission control processing.

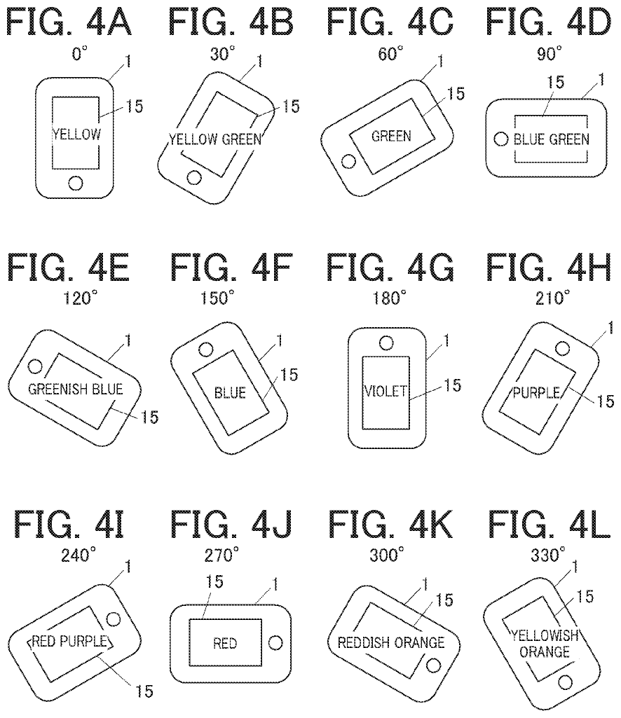

In a case where it is determined in step S1 that the state in which the electronic device 1 is inclined horizontally has been detected (YES in step S1), the CPU 11 sets the direction (orientation) of the device when the state in which the electronic device 1 is inclined horizontally is detected as a reference (step S2). Since the electronic device 1 is not rotating when the reference is set, the CPU 11 converts “0°” which is information about the item of “rotation angle in leftward direction from reference” or information about the item of “rotation angle in rightward direction from reference” at this time into “yellow” which is information about the item of “color of emitted light” by using the conversion table 131 (see FIG. 2), and causes the screen of the display 15 to emit light in yellow on the basis of the information about the item of “color of emitted light” (step S2; see FIG. 4A).

Then, the CPU 11 determines whether a rotation of the electronic device 1 around the direction of gravity (vertical line) has been detected (step S3).

In a case where it is determined in step S3 that a rotate of the electronic device 1 has not been detected (NO in step S3), the CPU 11 returns to step S2 to repeatedly perform processing thereafter. In a case where it is determined in step S3 that a rotate of the electronic device 1 has been detected (YES in step S3), the CPU 11 gradually changes the display color (the color of emitted light) of the screen of the display 15 in accordance with the rotation direction and rotation angle of the electronic device 1 (step S4).

For example, as shown in FIG. 4B, in a case where the electronic device 1 is rotated by 30° in the rightward direction from the reference, the CPU 11 converts “30°” which is information about the item of “rotation angle in rightward direction from reference” at this time into “yellow green” which is information about the item of “color of emitted light” by using the conversion table 131 (see FIG. 2), and causes the screen of the display 15 to emit light in yellow green on the basis of information about the item of the “color of emitted light”. Further, as shown in FIG. 4C to FIG. 4L, each time the electronic device 1 is rotated by 60°, 90°, . . . , and 330° in the rightward direction from the reference, the CPU 11 converts information about the item of “rotation angle in rightward direction from reference” in each level into information about the item of “color of emitted light” corresponding to the information by using the conversion table 131, and changes the display color of the screen of the display 15 on the basis of information about the item of the “color of emitted light”.

Then, the CPU 11 determines whether a state in which the electronic device 1 is erected in the direction of gravity, that is, the state in which the electronic device 1 is not inclined horizontally (for example, a state in which a user holds the electronic device 1 in hand, or the like) has been detected on the basis of sensing data acquired from the sensor 17 (step S5).

In a case where it is determined in step S5 that the state in which the electronic device 1 is erected in the direction of gravity has not been detected (NO in step S5), the CPU 11 returns to step S4 to repeatedly perform processing thereafter.

In a case where it is determined in step S5 that the state in which the electronic device 1 is erected in the direction of gravity has been detected (YES in step S5), the CPU 11 causes light emission of the screen of the display 15 to be continued in the display color (the color of emitted light) immediately before the state in which the electronic device 1 is erected in the direction of gravity is detected (step S6), and terminates the light emission control processing.

As described above, the electronic device 1 of the present embodiment exerts control so as to detect a rotation of the device, specify the level of the detected rotation (rotation angle) from a rotation-related plurality of levels previously set, and output a control signal based on the specified level (a signal for controlling the type of color of light emitted by the display 15 (information about the item of “color of emitted light”)).

Therefore, according to the electronic device 1, the color of emitted light of the screen of the display 15 can be changed by rotating the device. Thus, an operation of controlling the color of emitted light can be easily performed.

Further, according to the electronic device 1 of the present embodiment, a state in which the device is maintained at a predetermined rotation angle (the state in which the electronic device 1 is inclined horizontally) is detected as a reference state. The level of the detected rotation is specified from the rotation-related plurality of levels previously set on the basis of the reference state and the detected rotation angle. Thus, a user can easily understand the correspondence between the rotation angle of the electronic device 1 and the color of emitted light of the screen of the display 15. As a result, an operation of controlling the color of emitted light of the screen of the display 15 to be a user desired color of emitted light can be easily performed.

### Second Embodiment

A second embodiment will be described. Components similar to those of the first embodiment will be provided with the same reference characters, and their description will be omitted.

The electronic device 1 of the second embodiment is characterized in that an avatar image displayed on the display 15 is changed in accordance with the rotation direction and the rotation angle of the device from the reference.

### Configuration of Electronic Device 1

The electronic device 1 of the second embodiment is configured to include the CPU 11, the RAM 12, the memory 13, the transceiver 14, the display 15, the operation interface 16, and the sensor 17, similarly to the electronic device 1 of the first embodiment.

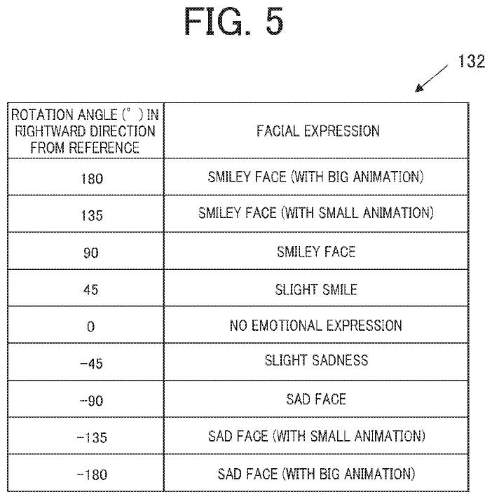

A conversion table 132 (see FIG. 5) is stored in the memory 13. The memory 13 is provided with an avatar image memory 133 that stores an avatar image previously set on the basis of a user operation. Avatar images in a plurality of patterns (for example, an expressionless avatar image, an avatar image with a smiley face, an avatar image with a sad face, and the like) to be used as a basis when changing the facial expression are stored in the avatar image memory 133.

FIG. 5 is a diagram showing the conversion table 132.

As shown in FIG. 5, in the conversion table 132, information about the item of “rotation angle in rightward direction from reference” and information about the item of “facial expression (facial expression of avatar image)” are associated with each other, and the information about the item of “rotation angle in rightward direction from reference” can be converted into information about the item of “facial expression”. For example, in a case where the information about the item of “rotation angle in rightward direction from reference” is 90°, the information is converted into “smiley face” which is information about the item of “facial expression”.

### Display Control Processing

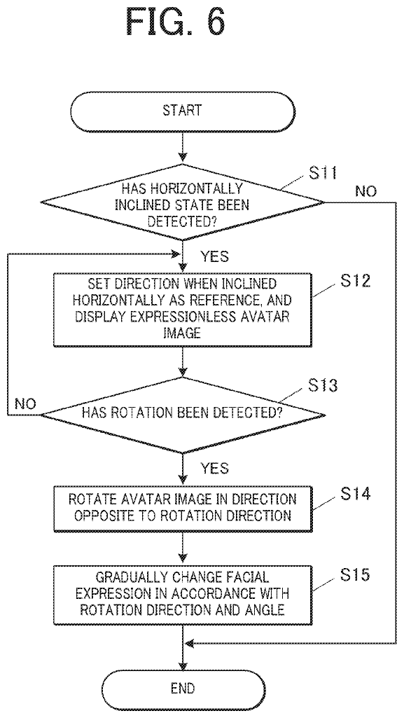

Display control processing executed in the electronic device 1 will be described with reference to FIG. 6. FIG. 6 is a flowchart showing the display control processing.

First, the CPU 11 of the electronic device 1 determines whether the state in which the electronic device 1 is inclined horizontally has been detected on the basis of sensing data acquired from the sensor 17 (step S11).

In a case where it is determined in step S11 that the electronic device 1 is inclined horizontally has not been detected (NO in step S11), the CPU 11 terminates the display control processing.

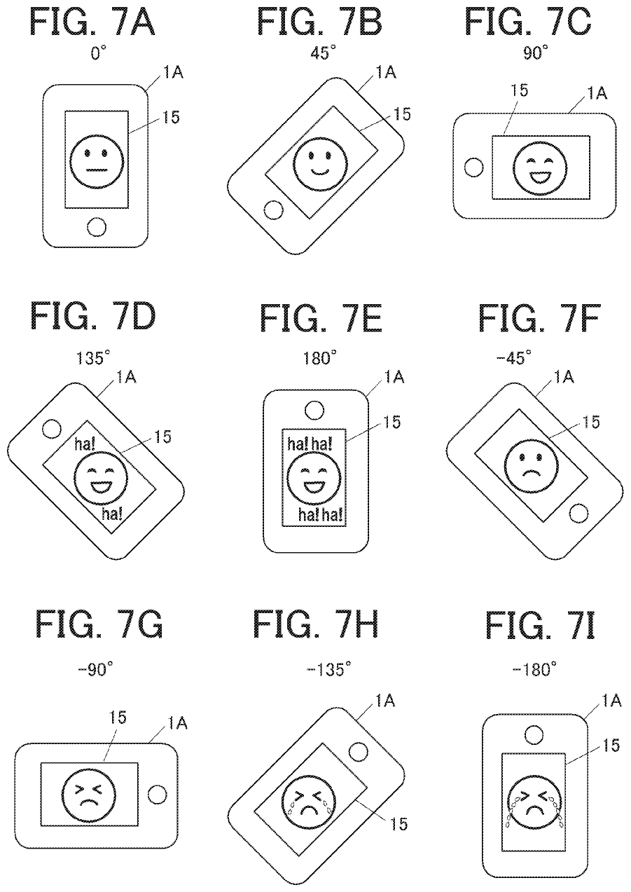

In a case where it is determined in step S11 that the electronic device 1 is inclined horizontally has been detected (YES in step S11), the CPU 11 sets the direction (orientation) of the device when the state in which the electronic device 1 is inclined horizontally is detected as a reference (step S12). Since the electronic device 1 is not rotating when the reference is set, the CPU 11 converts “0°” which is information about the item of “rotation angle in rightward direction from reference” at this time into “no emotional expression” which is information about the item of “facial expression” by using the conversion table 132 (see FIG. 5), and causes the expressionless avatar image stored in the avatar image memory 133 to be displayed on the display 15 on the basis of the information about the item of “facial expression” (step S12; see FIG. 7A).

Then, the CPU 11 determines whether a rotation of the electronic device 1 around the direction of gravity has been detected (step S13).

In a case where it is determined in step S13 that a rotation of the electronic device 1 has not been detected (NO in step S13), the CPU 11 returns to step S12 to repeatedly perform processing thereafter.

In a case where it is determined in step S13 that a rotation of the electronic device 1 has been detected (YES in step S13), the CPU 11 turns the avatar image by an angle equivalent to the rotation angle in the direction opposite to the rotation direction of the electronic device 1 for the purpose of always keeping the avatar image displayed on the display 15 horizontal (step S14).

Then, the CPU 11 gradually changes the facial expression of the avatar image displayed on the display 15 in accordance with the rotation direction and rotation angle of the electronic device 1 (step S15), and terminates the display control processing.

As shown in FIG. 7B to FIG. 7E, for example, each time the electronic device 1 is rotated by 45°, 90°, 135°, and 180° in the rightward direction from the reference, the CPU 11 converts information about the item of “rotation angle in rightward direction from reference” in each level (45°, 90°, 135°, and 180°) into information about the item of “facial expression” corresponding to the information (slight smile, smiley face, smiley face (with small animation), and smiley face (with big animation)) by using the conversion table 132, and deforms the avatar image with a smiley face stored in the avatar image memory 133 to a relevant facial expression on the basis of the information about the item of “facial expression” to be displayed on the display 15. As shown in FIG. 7F to FIG. 7I, each time the electronic device 1 is rotated by −45°, −90°, −135°, and −180° in the rightward direction from the reference, the CPU 11 converts information about the item of “rotation angle in rightward direction from reference” in each level (−45°, −90°, −135°, and −180°) into information about the item of “facial expression” (slight sadness, sad face, sad face (with small animation), and sad face (with big animation)) corresponding to the information by using the conversion table 132, and deforms the avatar image with a sad face stored in the avatar image memory 133 to a relevant facial expression on the basis of the information about the item of “facial expression” to be displayed on the display 15.

As described above, the electronic device 1 of the present embodiment exerts control so as to detect a rotation of the device, specify the level of the detected rotation (rotation direction and rotation angle) from a rotation-related plurality of levels previously set, and output a control signal based on the specified level (a signal for controlling a change in facial expression of an avatar image displayed by the display 15 (information about the item of “facial expression”)).

Therefore, in accordance with the electronic device 1, the facial expression of the avatar image displayed on the display 15 can be changed by rotating the device. Thus, an operation of controlling the facial expression of the avatar image can be easily performed.

The electronic device 1 of the present embodiment also exerts control such that the avatar image displayed on the display 15 is always kept horizontal when controlling a change in facial expression of the avatar image on the basis of the control signal based on the specified level. Thus, the avatar image displayed on the display 15 can be made easier to view even if the electronic device 1 is rotated to any rotation angle.

### Third Embodiment

The electronic device 1 of a third embodiment is characterized in that an image to be displayed on the display 15 is changed in accordance with the rotation direction and the rotation angle of the device from the reference.

### Configuration of Electronic Device 1

The electronic device 1 of the third embodiment is configured to include the CPU 11, the RAM 12, the memory 13, the transceiver 14, the display 15, the operation interface 16, and the sensor 17, similarly to the electronic device 1 of the first embodiment and the like.

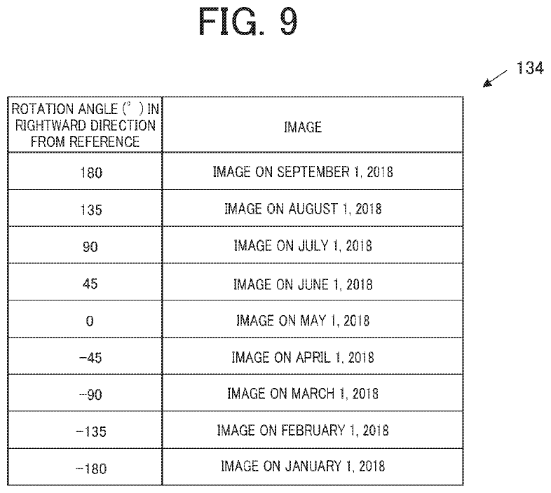

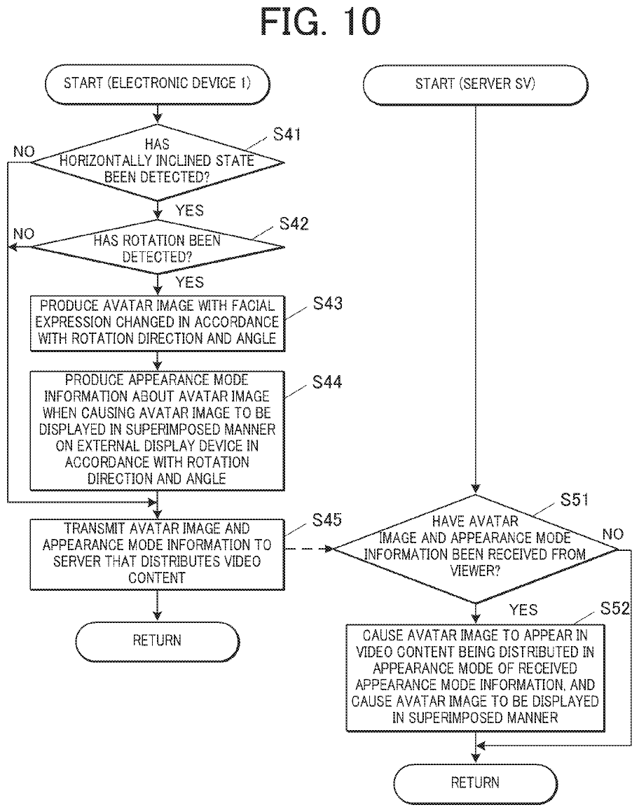

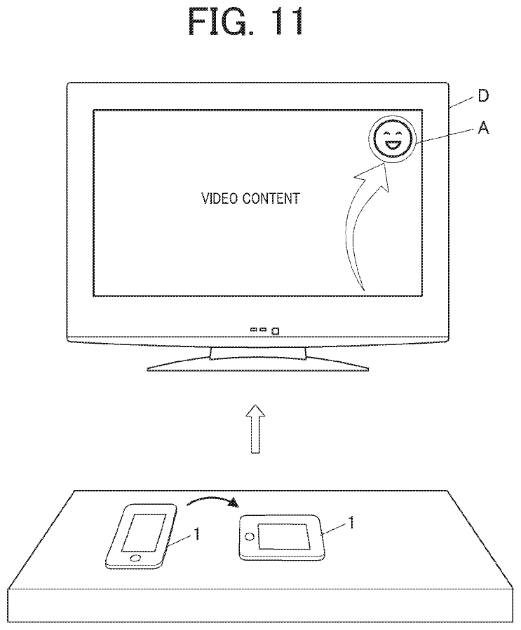

A conversion table 134 (see FIG. 9) is stored in the memory 13. The conversion table 134 is rewritten each time display control processing which will be described later is executed by the electronic device 1. The memory 13 is provided with an image memory (memory) that stores a plurality of image files, each of which is associated with shooting date and time information indicating a shooting date and time.

### Display Control Processing

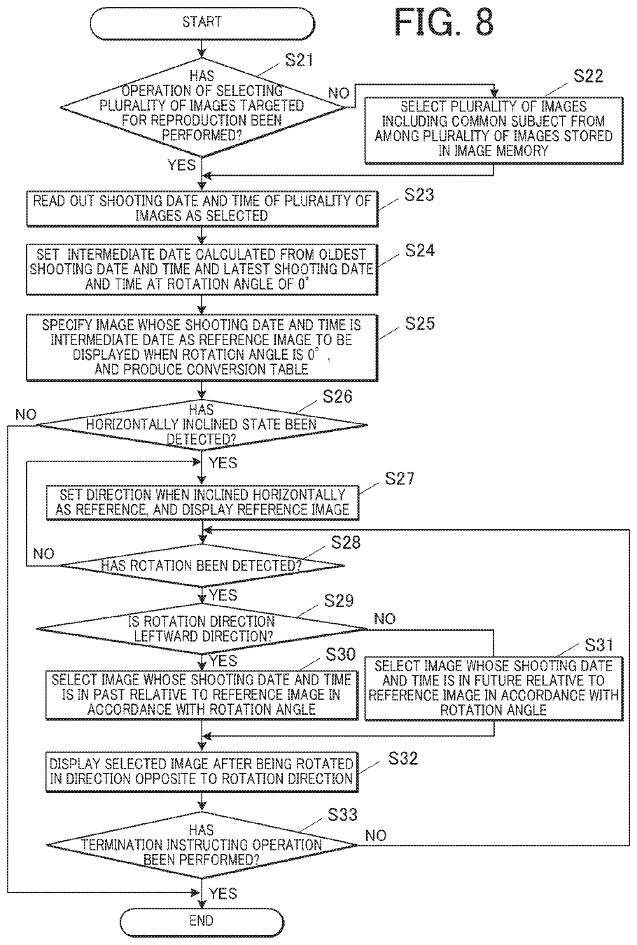

Display control processing executed in the electronic device 1 will be described with reference to FIG. 8. FIG. 8 is a flowchart showing the display control processing.

First, the CPU 11 of the electronic device 1 determines whether an operation of selecting a plurality of images (for example, images obtained by shooting a child, or the like) targeted for reproduction from among a plurality of image files stored in the image memory has been performed via the operation interface 16 (step S21).

In a case where it is determined in step S21 that an operation of selecting a plurality of images targeted for reproduction from among the plurality of image files held in the image memory has been performed (YES in step S21), the CPU 11 reads out shooting date and time information about the plurality of images from the image memory (step S23).

In a case where it is determined in step S21 that an operation of selecting a plurality of images targeted for reproduction from among the plurality of image files stored in the image memory has not been performed (NO in step S21), the CPU 11 arbitrarily selects a predetermined number of images (for example, nine images) including a common subject (for example, a person, plant, or the like) from among the plurality of image files stored in the image memory (step S22), and reads out shooting date and time information about the plurality of images from an image memory 135 (step S23).

Then, the CPU 11 calculates, from the oldest shooting date and time and the latest shooting date and time, an intermediate date between them on the basis of each piece of the shooting date and time information read out in step S23, and sets the intermediate date at the rotation angle of 0° (step S24). Specifically, in a case where nine shooting dates and times of Jan. 1, 2018, Feb. 1, 2018, Mar. 1, 2018, Apr. 1, 2018, May 1, 2018, Jun. 1, 2018, Jul. 1, 2018, Aug. 1, 2018, and Sep. 1, 2018, for example, are read out in step S23 as shooting dates and times, the CPU 11 calculates, from the oldest shooting date and time (Jan. 1, 2018) and the latest shooting date and time (Sep. 1, 2018), an intermediate date (May 1, 2018) between them, and sets the intermediate date at the rotation angle of 0°. In a case where there is no shooting date and time relevant to the calculated intermediate date, the CPU 11 sets a shooting date and time closest to the intermediate date at the rotation angle of 0°.

Then, the CPU 11 specifies an image whose shooting date and time is the intermediate date as a reference image to be displayed when the rotation angle is 0°, and produces the conversion table 134 (step S25). Specifically, in a case where nine shooting dates and times from Jan. 1, 2018 to Sep. 1, 2018, for example, are read out as shooting dates and times, and May 1, 2018 (intermediate date) is set at the rotation angle of 0° as described above, the CPU 11 sets an image whose shooting date and time is May 1, 2018 as a reference image to be displayed when the rotation angle is 0° while producing the conversion table 134, as shown in FIG. 9. The CPU 11 also sets four images whose shooting dates and times are Jun. 1, 2018, Jul. 1, 2018, Aug. 1, 2018, Sep. 1, 2018 that are in the future relative to May 1, 2018 as images to be displayed when the rotation angle is 45°, 90°, 135°, and 180°, respectively. The CPU 11 sets four images whose shooting dates and times are Apr. 1, 2018, Mar. 1, 2018, Feb. 1, 2018, and Jan. 1, 2018 that are in the past relative to May 1, 2018 as images to be displayed when the rotation angle is −45°, −90°, −135°, and −180°, respectively. The rotation angle allocated to each image is set in accordance with the number of images that are in the future relative to the reference image and the number of images that are in the past.

Then, the CPU 11 determines whether the state in which the electronic device 1 is inclined horizontally has been detected on the basis of sensing data acquired from the sensor 17 (step S26).

In a case where it is determined in step S26 that the state in which the electronic device 1 is inclined horizontally has not been detected (NO in step S26), the CPU 11 terminates the display control processing.

In a case where it is determined in step S26 that the state in which the electronic device 1 is inclined horizontally has been detected (YES in step S26), the CPU 11 sets the direction (orientation) of the device when the state in which the electronic device 1 is inclined horizontally is detected as a reference (step S27). Since the electronic device 1 is not rotating when the reference is set, the CPU 11 converts “0°” which is information about the item of “rotation angle in rightward direction from reference” at this time into information about the item of “image” (for example, an image on May 1, 2018) by using the conversion table 134 (see FIG. 9), and causes the image shot on May 1, 2018 (the reference image) to be displayed on the display 15 on the basis of the information about the item of “image” (step S27).

Then, the CPU 11 determines whether a rotation of the electronic device 1 around the direction of gravity has been detected (step S28).

In a case where it is determined in step S28 that a rotation of the electronic device 1 has not been detected (NO in step S28), the CPU 11 returns to step S27 to repeatedly perform processing thereafter.

In a case where it is determined in step S28 that a rotation of the electronic device 1 has been detected (YES in step S28), the CPU 11 determines whether the rotation direction is the leftward direction (counterclockwise direction) (step S29).

In a case where it is determined in step S29 that the rotation direction is the leftward direction (YES in step S29), the CPU 11 selects an image whose shooting date and time is in the past relative to the reference image in accordance with the rotation angle of the rotation (step S30). Specifically, in a case where the electronic device 1 is rotated by 45° in the leftward direction, the CPU 11 selects an image on Apr. 1, 2018 by using the conversion table 134 shown in FIG. 9, for example.

In a case where it is determined in step S29 that the rotation direction is not the leftward direction, that is, the rotation direction is the rightward direction (clockwise) (NO in step S29), the CPU 11 selects an image whose shooting date and time is in the future relative to the reference image in accordance with the rotation angle of the rotation (step S31). Specifically, in a case where the electronic device 1 is rotated by 90° in the rightward direction, the CPU 11 selects an image on Jul. 1, 2018 by using the conversion table 134 shown in FIG. 9, for example.

Then, for the purpose of always keeping the image selected in step S30 or step S31 horizontal, the CPU 11 causes the image to be displayed after being rotated in the direction opposite to the rotation direction of the electronic device 1 by an angle equivalent to the rotation angle (step S32).

Then, the CPU 11 determines whether a termination instructing operation of terminating the display control processing has been performed via the operation interface 16 (step S33).

In a case where it is determined in step S33 that the termination instructing operation has not been performed (NO in step S33), the CPU 11 returns to step S28 to repeatedly perform processing thereafter.

In a case where it is determined in step S33 that the termination instructing operation has been performed (YES in step S33), the CPU 11 terminates the display control processing.

As described above, the electronic device 1 of the present embodiment exerts control so as to detect a rotation of the device, specify the level of the detected rotation (rotation direction and rotation angle) from a rotation-related plurality of levels previously set, and output a control signal based on the specified level (a signal for selecting an image to be read out from the image memory 135 (information about the item of “image”)).

Therefore, in accordance with the electronic device 1 of the present embodiment, an image to be displayed on the display 15 can be changed by rotating the device. Thus, an operation of controlling a change of the image can be easily performed.

Further, in accordance with the electronic device 1 of the present embodiment, the rotation direction and rotation angle of the electronic device 1 and information having continuity are associated with each other to set the conversion table 134, and an image to be displayed on the display 15 can be changed by using the conversion table 134. Thus, an operation of controlling a change of an image among a plurality of images previously selected by a user can be easily performed. Since information having continuity associated with the rotation direction and rotation angle of the electronic device 1 is shooting date and time information, the image displayed on the display 15 can be changed in a chronological order by rotating the electronic device 1.

### Fourth Embodiment

A fourth embodiment will be described. The electronic device 1 of the fourth embodiment is characterized in that an avatar image with a facial expression changed in accordance with the rotation direction and rotation angle of the device is displayed in a superimposed manner on video content displayed on an external display device (external device).

### Display Control Processing

Display control processing executed by a cooperation between the electronic device 1 and a server SV that distributes video content will be described with reference to FIG. 10. The left flowchart in FIG. 10 is a flowchart showing processing performed by the electronic device 1, and the right flowchart in the drawing is a flowchart showing processing performed by the server SV.

First, the CPU 11 of the electronic device 1 determines whether the state in which the electronic device 1 is inclined horizontally has been detected on the basis of sensing data acquired from the sensor 17 (step S41).

In a case where it is determined in step S41 that the state in which the electronic device 1 is inclined horizontally has not been detected (NO in step S41), the CPU 11 terminates the display control processing.

In a case where it is determined in step S41 that the state in which the electronic device 1 is inclined horizontally has been detected (YES in step S41), the CPU 11 determines whether a rotation of the electronic device 1 around the direction of gravity has been detected (step S42).

In a case where it is determined in step S42 that a rotation of the electronic device 1 has not been detected (NO in step S42), the CPU 11 terminates the display control processing.

In a case where it is determined in step S42 that a rotation of the electronic device 1 has been detected (YES in step S42), the CPU 11 produces an avatar image with a facial expression changed in accordance with the rotation direction and rotation angle of the electronic device 1 (step S43). For example, in a case where the electronic device 1 is rotated by 90° in the rightward direction from the reference, the CPU 11 produces an avatar image with a facial expression (smiley face) changed in accordance with the rotation direction and rotation angle of the electronic device 1 by using the conversion table 132 (see FIG. 5).

Then, the CPU 11 produces appearance mode (display mode) information about the avatar image when causing the avatar image to be displayed in a superimposed manner on an external display device in accordance with the rotation direction and rotation angle of the electronic device 1 (step S44). Herein, in the conversion table 132 of the present embodiment, appearance mode information (for example, information such as an appearing position, a moving speed, and a moving route of an avatar image) is further associated with information about the item of “rotation angle in rightward direction from reference” although illustration is omitted, and the CPU 11 is capable of producing the above-described appearance mode information in accordance with the rotation direction and rotation angle of the electronic device 1 by using the conversion table 132.

Then, the CPU 11 transmits the avatar image produced in step S43 and the appearance mode information produced in step S44 to the server SV via the transceiver 14 (step S45), and terminates the display control processing.

The server SV determines whether the avatar image and appearance mode information have been received from the electronic device 1 of a viewer (step S51). Herein, the viewer refers to a user who has previously subscribed a predetermined service for causing an avatar image to be displayed in a superimposed manner on video content distributed by the server SV.

In a case where it is determined in step S51 that the avatar image and appearance mode information have not been received from the electronic device 1 of the viewer (NO in step S51), the server SV terminates the display control processing.

In a case where it is determined in step S51 that the avatar image and appearance mode information have been received from the electronic device 1 of the viewer (YES in step S51), the server SV causes the avatar image to appear in an appearance mode of the received appearance mode information, and then causes the avatar image to be displayed in a superimposed manner on video content being distributed (step S52), and terminates the display control processing.

FIG. 11 is a representative diagram showing an outline when the above-described display control processing is executed by a cooperation between the electronic device 1 and the server SV.

As shown in FIG. 11, in a case where this electronic device 1 is rotated by 90° in the rightward direction from the reference, for example, in the state in which the electronic device 1 is inclined horizontally, the CPU 11 produces an avatar image with a smiley face A (see FIG. 7C) by using the conversion table 132 (see FIG. 5), and produces appearance mode information about the avatar image A (for example, information such as the appearing position of the avatar image A=an upper right region of the screen, the moving speed=medium level, the moving route=moving from the lower side of the screen while turning to the right) when causing the avatar image A to be displayed in a superimposed manner on an external display device D, and transmits these types of information to the server SV. The server SV causes the avatar image A to appear at the lower side of the screen of the display device D and to move at a medium level speed to the upper right region of the screen while turning to the right on the basis of the avatar image A and appearance mode information received from the electronic device 1, to cause the avatar image A to be displayed in a superimposed manner on video content being displayed (distributed) on the display device D.

As described above, the electronic device 1 of the present embodiment detects a rotation of the device, specifies the level of the detected rotation (rotation direction and rotation angle) from a rotation-related plurality of levels previously set, produces a control signal based on the specified level (a signal for controlling a change in avatar image to be displayed on the display device D and a signal for controlling an appearance mode of the avatar image to be displayed on the display device D), and transmits the control signal to the server SV via the transceiver 14.

Therefore, in accordance with the electronic device 1, the facial expression of the avatar image displayed in a superimposed manner on video content displayed on the display device D (video content distributed from the server SV) can be changed, and the appearance mode of the avatar image when causing the avatar image to be displayed in a superimposed manner on the display device D by rotating the device. Thus, an operation of controlling a change in facial expression of the avatar image and a change in appearance mode of the avatar image can be easily performed.

### Fifth Embodiment

A fifth embodiment will be described. Components similar to those of each of the first to fourth embodiments will be provided with the same reference characters, and their description will be omitted.

The electronic device 1 of the fifth embodiment is characterized in that a re-notification time in a snooze function is set in accordance with the rotation direction and the rotation angle of the device from the reference.

### Configuration of Electronic Device 1

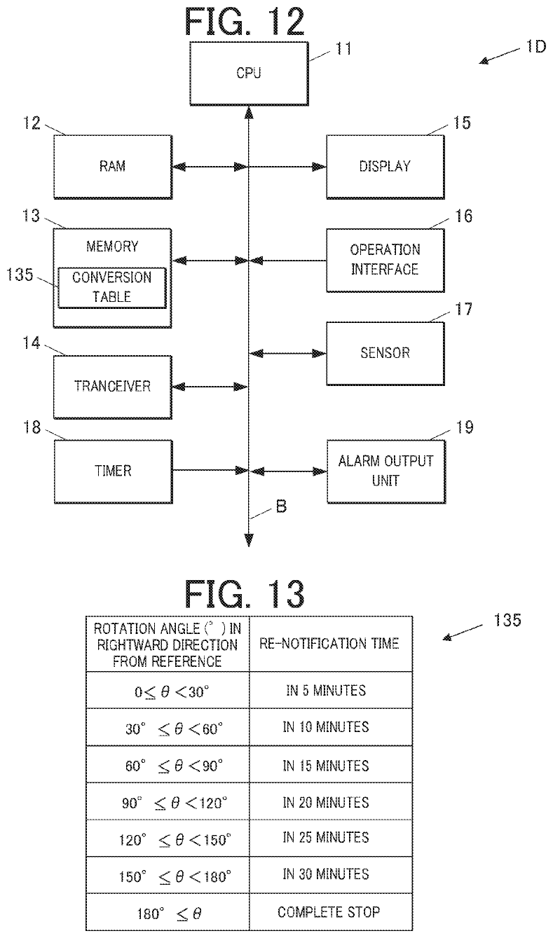

FIG. 12 is a block diagram showing a functional configuration of the electronic device 1 of the fifth embodiment.

As shown in FIG. 12, the electronic device 1 of the fifth embodiment is configured to further include a timer 18 and an alarm output unit (alarm notifier) 19 in addition to the CPU 11, the RAM 12, the memory 13, the transceiver 14, the display 15, the operation interface 16, and the sensor 17.

A conversion table 135 to be used when setting a re-notification time (alarm time) in the snooze function is stored in the memory 13.

FIG. 13 is a diagram showing the conversion table 135.

As shown in FIG. 13, in the conversion table 135, information about the item of “rotation angle in rightward direction from reference” and information about the item of “re-notification time” are associated with each other, and information about the item of “rotation angle in rightward direction from reference” can be converted into information about the item of “re-notification time”. For example, in a case where information about the item of “rotation angle in rightward direction from reference” is 0°≤θ<90°, the information is converted into “in 5 minutes” which is information about the item of “re-notification time”. In a case where information about the item of “rotation angle in rightward direction from reference” is 180°≤θ, the information is converted into “complete stop” which is information about the item of “re-notification time”.

The timer 18 is a real-time clock, which clocks the current date and time, and outputs information about the current date and time to the CPU 11.

The alarm output unit 19 is composed of a DA converter, an amplifier, a speaker, and the like. The alarm output unit 19 converts an alarm output signal into an analog alarm output signal when notifying alarm to perform alarm notification through the speaker.

### Alarm Notification Control Processing

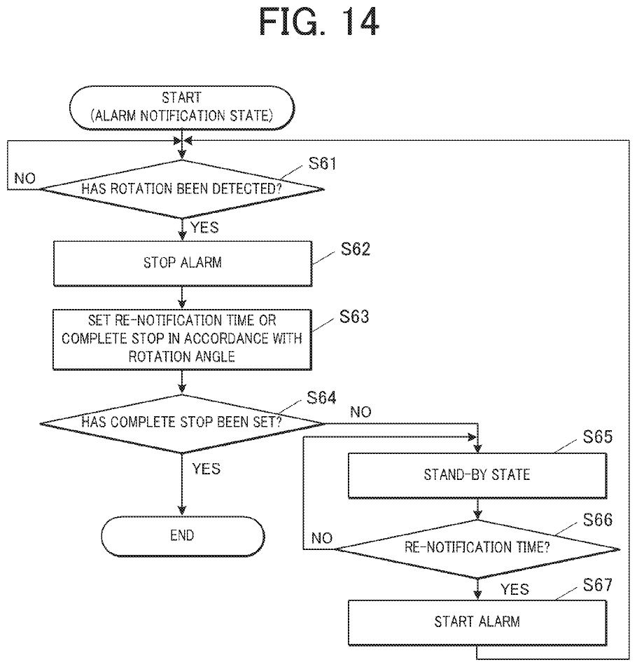

Alarm notification control processing executed in the electronic device 1 will be described with reference to FIG. 14. FIG. 14 is a flowchart showing the alarm notification control processing. Herein, the alarm notification control processing is processing triggered by alarm notification being performed at a predetermined time by the alarm function that the electronic device 1 has. Further, the alarm notification control processing is processing executed in the state in which the electronic device 1 is inclined horizontally.

First, the CPU 11 of the electronic device 1 determines whether a rotation of the electronic device 1 around the direction of gravity has been detected (step S61).

In a case where it is determined in step S61 that a rotation of the electronic device 1 has not been detected (NO in step S61), the CPU 11 repeatedly performs the determination processing of step S61 until a rotation of the electronic device 1 is detected.

In a case where it is determined in step S61 that a rotation of the electronic device 1 has been detected (YES in step S61), the CPU 11 stops alarm notification by the alarm output unit 19 (step S62).

Then, the CPU 11 sets the re-notification time or complete stop in accordance with the rotation angle of the electronic device 1 (step S63). Specifically, the CPU 11 sets the re-notification time to be in 5 minutes in a case where the rotation angle θ of the electronic device 1 satisfies the relation of 0°≤θ<30°, sets the re-notification time to be in 10 minutes in a case where the rotation angle θ satisfies the relation of 30°≤θ<60°, . . . , and sets the re-notification time to be in 30 minutes in a case where the rotation angle θ satisfies the relation of 150°≤θ<180° by using the conversion table 135 (see FIG. 13). In a case where the rotation angle θ of the electronic device 1 satisfies the relation of 180°≤θ, the CPU 11 sets the complete stop of alarm notification rather than setting the re-notification time.

Then, the CPU 11 determines in step S63 whether the complete stop of alarm notification has been set (step S64).

In a case where it is determined in step S64 that the complete stop of alarm notification has been set (YES in step S64), the CPU 11 terminates the alarm notification control processing.

In a case where it is determined in step S64 that the complete stop of alarm notification has not been set, that is, the re-notification time has been set (NO in step S64), the CPU 11 transitions to a stand-by state (step S65).

Then, the CPU 11 determines whether the re-notification time set in step S63 has arrived on the basis of information about the current date and time clocked by the timer 18 (step S66).

In a case where it is determined in step S66 that the re-notification time has not arrived (NO in step S66), the CPU 11 returns to step S65 to repeatedly perform processing thereafter.

In a case where it is determined in step S66 that the re-notification time has arrived (YES in step S66), the CPU 11 starts alarm notification through the alarm output unit 19 (step S67), and returns to step S61 to repeatedly perform processing thereafter.

As described above, the electronic device 1 of the present embodiment exerts control so as to detect a rotation of the device, specify the level of the detected rotation (rotation angle) from a rotation-related plurality of levels previously set, and output a control signal based on the specified level (a signal for controlling an alarm time (information about the item of “re-notification time”)).

Therefore, in accordance with the electronic device 1, the re-notification time related to the snooze function can be set by rotating the device. Thus, an operation of controlling setting of the re-notification time can be easily performed.

### Sixth Embodiment

A sixth embodiment will be described. Components similar to those of each of the first to fifth embodiments will be provided with the same reference characters, and their description will be omitted.

The electronic device 1 of the sixth embodiment is characterized in that emitted light color data when remotely controlling an illumination device is produced in accordance with the rotation angle of the device from a reference, and luminance data is produced in accordance with a moving direction and moving speed of the device.

### Configuration of Electronic Device 1

The electronic device 1 of the sixth embodiment is configured to include the CPU (a third detector, a second specifier) 11, the RAM 12, the memory 13, the transceiver 14, the display 15, the operation interface 16, and the sensor 17, similarly to the electronic device 1 of the first embodiment and the like.

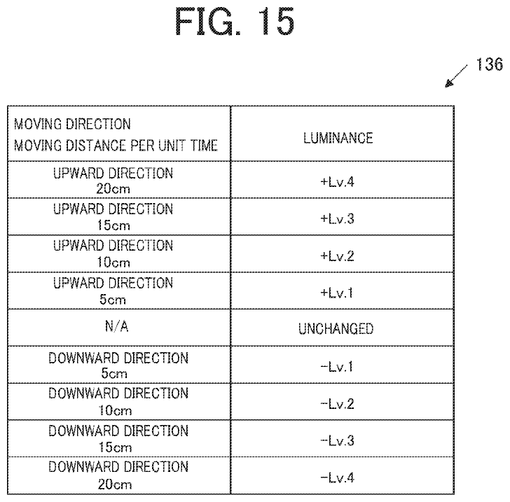

A luminance conversion table 136 (see FIG. 15) in addition to the conversion table 131 is further stored in the memory 13.

FIG. 15 is a diagram showing the luminance conversion table 136.

As shown in FIG. 15, in the luminance conversion table 136, information about the item of “moving direction and moving distance per unit time” and information about the item of “luminance” are associated with each other, and information about the item of “moving direction and moving distance per unit time” can be converted into information about the item of “luminance”. For example, in a case where information about the item of “moving direction and moving distance per unit time” indicates the upper direction and 20 cm, the information is converted into “+Lv.4” which is information about the item of “luminance”. Herein, the moving direction refers to the vertical direction of the electronic device 1, a movement in the upward direction means an action of sliding the device to above the upper edge of the electronic device 1, and a movement in the downward direction means an action of sliding the device to below the lower edge of the electronic device 1.

### Lighting Device Control Processing

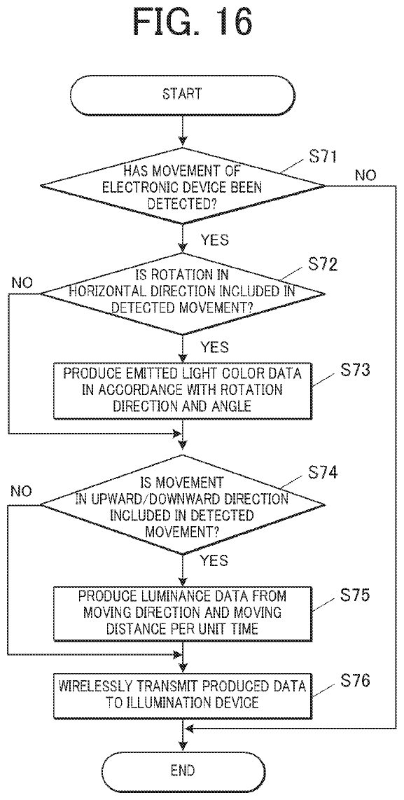

Lighting device control processing executed in the electronic device 1 will be described with reference to FIG. 16. FIG. 16 is a flowchart showing the illumination device control processing.

First, the CPU 11 of the electronic device 1 determines whether a movement of the device has been detected on the basis of sensing data acquired from the sensor 17 (step S71).

In a case where it is determined in step S71 that a movement of the device has not been detected (NO in step S71), the CPU 11 terminates the illumination device control processing.

In a case where it is determined in step S71 that a movement of the device has been detected (YES in step S71), the CPU 11 determines whether a rotation in the horizontal direction (a rotating around the direction of gravity) is included in the movement of the electronic device 1 (step S72).

In a case where it is determined in step S72 that a rotation in the horizontal direction is included in the movement of the electronic device 1 (YES in step S72), the CPU 11 produces emitted light color data indicating the color of emitted light when remotely controlling an illumination device in accordance with the rotation angle of the rotation (step S73), and transitions to step S74.

In a case where it is determined in step S72 that a rotation in the horizontal direction is not included in the movement of the electronic device 1 (NO in step S72), the CPU 11 skips step S73, and transitions to step S74.

Then, the CPU 11 determines whether a movement in the upward/downward direction (the vertical direction of the electronic device 1) is included in the movement of the electronic device 1 on the basis of sensing data acquired from the sensor 17 (step S74).

In a case where it is determined in step S74 that a movement in the upward/downward direction is included in the movement of the electronic device 1 (YES in step S74), the CPU 11 produces luminance data indicating luminance when remotely controlling the illumination device in accordance with the moving direction of the movement and the moving distance per unit time (step S75), and transitions to step S76.

In a case where it is determined in step S74 that a movement in the upward/downward direction is not included in the movement of the electronic device 1 (NO in step S74), the CPU 11 skips step S75, and transitions to step S76.

Then, the CPU 11 wirelessly transmits the data produced in step S73 and/or step S75 to the illumination device (not shown) via the transceiver 14 (step S76), and terminates the illumination device control processing. Accordingly, the illumination device having received the above-described data emits light in the color of emitted light and/or luminance indicated by the data.

As described above, the electronic device 1 of the present embodiment detects a rotation of the device, specifies the level of the detected rotation (rotation angle) from a rotation-related plurality of levels previously set, produces a control signal based on the specified level (emitted light color data), and wirelessly transmits the control signal to the illumination device via the transceiver 14. The electronic device 1 also detects a linear movement of the device, specifies the level of the detected linear movement (moving direction and moving distance per unit time) from a linear-movement-related plurality of levels previously set, produces a control signal based on the specified level (luminance data), and wirelessly transmits the control signal to the illumination device via the transceiver 14.

Therefore, in accordance with the electronic device 1, the color of emitted light and luminance of the illumination device can be changed by rotating the device and causing the device to make a linear movement. Thus, an operation of controlling the illumination device can be easily performed.

### Seventh Embodiment

A seventh embodiment will be described. Components similar to those of each of the first to sixth embodiments will be provided with the same reference characters, and their description will be omitted.

The electronic device 1 of the seventh embodiment is characterized in that a piece of command data is produced in accordance with the rotation direction and rotation angle when rotating the device around the direction of gravity, and the command data is transmitted to an audio player to operate the audio player.

### Configuration of Electronic Device 1

The electronic device 1 of the seventh embodiment is configured to include the CPU 11, the RAM 12, the memory 13, the transceiver 14, the display 15, the operation interface 16, and the sensor 17, similarly to the electronic device 1 of the first embodiment and the like.

A conversion table is stored in the memory 13. In this conversion table, information about the item of “rotation angle in rightward direction from reference” and information about the item of “display region of control menu” are associated with each other, and information about the item of “rotation angle in rightward direction from reference” can be converted into information about the item of “display region of control menu”. Herein, the control menu is an operation screen displayed on the display 15 when operating an audio player (not shown). In this control menu, respective icons (control icons) of “Artists”, “Player”, “Themes”, “Voice”, “EQ”, and “Songs”, for example, are displayed in a circle.

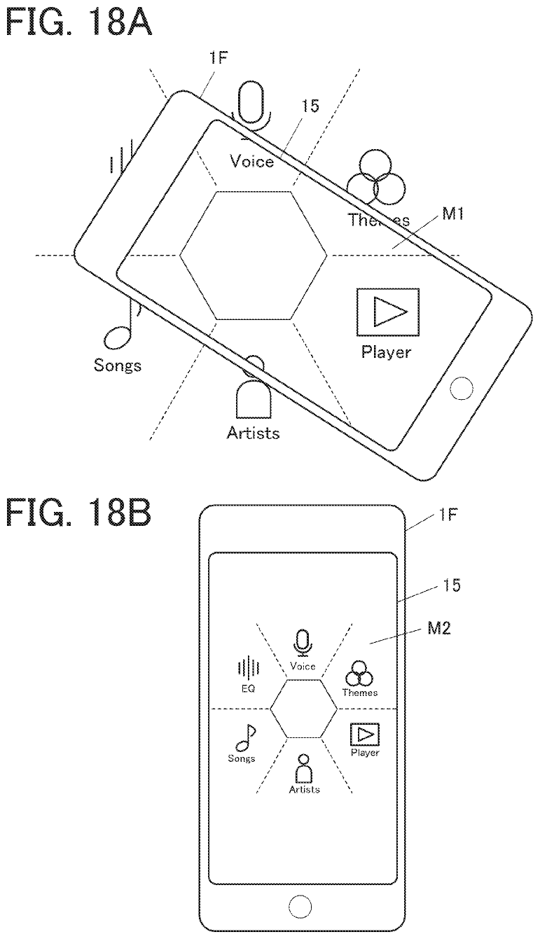

The above-described control menu is provided with a first control menu M1 in which the display region of the control menu is changed in accordance with the rotating direction and rotation angle when rotating the electronic device 1 as shown in FIG. 18A, and a second control menu M2 in which the control menu is displayed fixedly as shown in FIG. 18B.

The first control menu M1 is a control menu displayed on the display 15 when in the state in which the electronic device 1 is inclined horizontally. The second control menu M2 is a control menu displayed on the display 15 when in the state in which the electronic device 1 is not inclined horizontally.

### Audio Player Control Processing

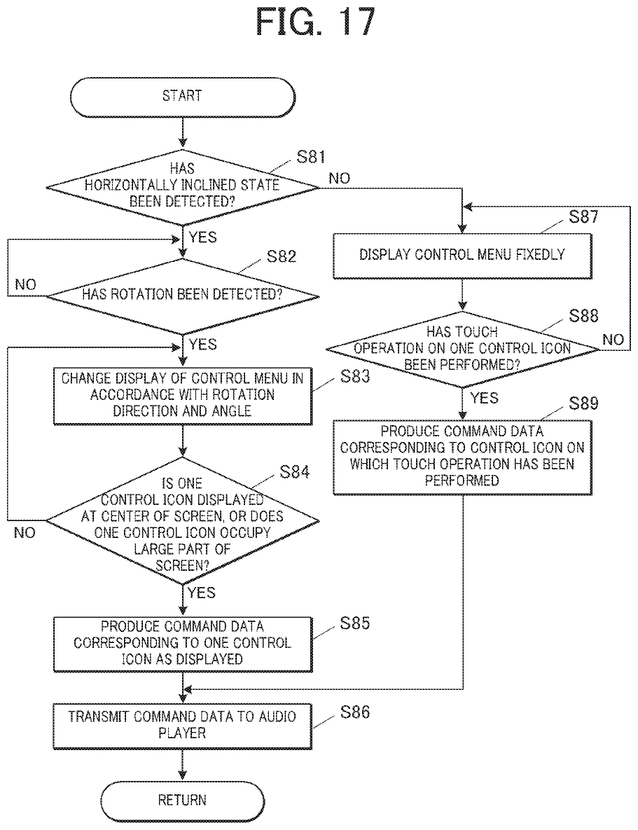

Audio player control processing executed in the electronic device 1 will be described with reference to FIG. 17. FIG. 17 is a flowchart showing the audio player control processing.

First, the CPU 11 of the electronic device 1 determines whether the state in which the electronic device 1 is inclined horizontally has been detected on the basis of sensing data acquired from the sensor 17 (step S81).

In a case where it is determined in step S81 that the state in which the electronic device 1 is inclined horizontally has been detected (YES in step S81), the CPU 11 determines whether a rotation of the electronic device 1 around the direction of gravity has been detected (step S82).

In a case where it is determined in step S82 that a rotation of the electronic device 1 around the direction of gravity has not been detected (NO in step S82), the CPU 11 repeatedly performs the determination processing of step S82 until the rotation of the electronic device 1 is detected.

In a case where it is determined in step S82 that a rotation of the electronic device 1 around the direction of gravity has been detected (YES in step S82), the CPU 11 changes the display region of the control menu (the first control menu M1; see FIG. 18A) displayed on the display 15 in accordance with the rotation direction and rotation angle of the electronic device 1 by using the conversion table (step S83).

Then, the CPU 11 determines whether one control icon is displayed at the center of the screen in the control menu (the first control menu M1) displayed on the display 15, or whether the one control icon occupies a large part of the screen (step S84).

In a case where it is determined in step S84 that one control icon is not displayed at the center of the screen, and the one control icon does not occupy a large part of the screen (NO in step S84), the CPU 11 returns to step S83 to repeatedly perform processing thereafter.

In a case where it is determined in step S84 that one control icon is displayed at the center of the screen, or the one control icon occupies a large part of the screen (YES in step S84), the CPU 11 produces command data corresponding to the one control icon (step S85). For example, in a case where the control icon of “Player” occupies a large part of the screen of the display 15 as shown in FIG. 18A, the CPU 11 produces command data corresponding to the control icon of “Player”.

Then, the CPU 11 transmits the command data produced in step S85 to the audio player (step S86), and terminates the audio player control processing.

In a case where it is determined in step S81 that the state in which the electronic device 1 is inclined horizontally has not been detected (NO in step S81), the CPU 11 displays the control menu (the second control menu M2; see FIG. 18B) on the display 15 (step S87).

Then, the CPU 11 determines whether a touch operation on one control icon has been performed from the control menu (the second control menu M2) displayed on the display 15 via the operation interface 16 (step S88).

In a case where it is determined in step S88 that a touch operation on one control icon has not been performed from the control menu (the second control menu M2) displayed on the display 15 (NO in step S88), the CPU 11 returns to step S87 to repeatedly perform processing thereafter.

In a case where it is determined in step S88 that a touch operation on one control icon has been performed from the control menu (the second control menu M2) displayed on the display 15 (YES in step S88), the CPU 11 produces command data corresponding to the control icon on which the touch operation has been performed (step S89).

Then, the CPU 11 transmits the command data produced in step S89 to the audio player (step S86), and terminates the audio player control processing.

As described above, the electronic device 1 of the present embodiment exerts control so as to detect a rotation of the device, specify the level of the detected rotation (rotation angle) from a rotation-related plurality of levels previously set, and output a control signal based on the specified level (a signal for controlling the display region of the first control menu M1 displayed on the display 15).

Therefore, in accordance with the electronic device 1, the display region of the first control menu M1 displayed on the display 15 can be changed by rotating the device. Thus, an operation of controlling the display region of the first control menu M1 can be easily performed.

Further, in accordance with the electronic device 1 of the present embodiment, a control icon when operating the audio player can be determined by rotating the device, command data corresponding to the control icon can be produced, and the command data can be transmitted to the audio player. Thus, an operation of controlling the audio player can be easily performed.

Although the embodiments of the present invention have been described above, it is needless to say that the present invention is not limited to such embodiments, but can be modified variously within the scope of the claims.

For example, in the above-described third embodiment, an intermediate date is calculated from the oldest shooting date and time and the latest shooting date and time on the basis of each piece of the shooting date and time information read out in step S23 in the display control processing (see FIG. 8). The intermediate date is set at the rotation angle of 0°, and an image whose shooting date and time is the intermediate date is set as a reference image to be displayed when the rotation angle is 0° to produce the conversion table 134. However, the method of producing the conversion table 134 is not limited to the above-described method.

For example, it may be configured such that a plurality of image files, each of which is associated with shooting information indicating a shooting position or shooting orientation, are stored in the image memory 135. Shooting information about a plurality of images as selected is read out in step S23 in the display control processing. In step S25, a reference image to be displayed when the rotation angle is 0° is specified using the orientation the electronic device 1 is facing when producing the conversion table 134 as a reference. Images captured in the east with respect to the shooting position of the reference image are set as images to be displayed when the rotation angle is 0° to 180°, respectively, and images captured in the west with respect to the shooting position of the reference image are set as images to be displayed when the rotation angle is 0° to −180°, respectively.

In the above-described fifth embodiment, the re-notification time in the snooze function is set in accordance with the rotation direction and the rotation angle of the electronic device 1 from the reference, however, it may be configured such that a timer time in the timer function that the device has can be set, for example. In a case where the electronic device 1 has a remote operating function for a domestic electric appliance (for example, an air conditioner or the like), it may be configured such that an adjustment parameter for the domestic electric appliance (for example, the temperature of the air conditioner or the like) can be set in accordance with the rotation direction and the rotation angle of the device from the reference.

Although the embodiments of the present invention have been described above, the scope of the present invention is not limited to the above-described embodiments, but includes the scope of the invention recited in the appended patent claims and the scope of its equivalents.

What is claimed is:

1. An electronic device comprising:
a sensor that acquires sensing data; and
a processor,
wherein the processor
determines, based on first sensing data acquired by the sensor, whether the electronic device is in a first posture state or not,
specifies a level of a second posture state of the electronic device among a plurality of levels, based on second sensing data that is acquired by the sensor after the processor determines whether the electronic device is in the first posture state, and
outputs a control signal based on the specified level.

2. The electronic device according to claim 1, wherein the processor specifies the level of the second posture state among the plurality of levels using the first posture state as a reference state.

3. The electronic device according to claim 1, wherein
the second posture state is a rotation state when the electronic device is rotated, and
the plurality of levels are a plurality of levels concerning a rotation speed or a plurality of levels concerning a rotation angle when the electronic device is rotated.

4. The electronic device according to claim 1, further comprising:
a light emitter that emits light in any of a plurality of colors,
wherein
the plurality of levels are levels based on an arrangement rule of a plurality of color types, and
the control signal is a signal for controlling a color type of light emitted by the light emitter.

5. The electronic device according to claim 1, further comprising:
a transceiver,
wherein
the plurality of levels are levels based on an arrangement rule of a plurality of color types of illuminating light of the illumination device, and
the processor transmits the control signal to the illumination device using the transceiver as a signal for controlling a color type of the illuminating light.

6. The electronic device according to claim 5, wherein the processor
further specifies, as the second posture state, a level of a moving state of the electronic device in a linear direction among a plurality of levels,
and
the control signal includes a control signal for controlling an illumination state of the illumination device based on the specified level.

7. The electronic device according to claim 6, wherein
the illumination state of the illumination device is a level of luminance when the illumination device produces light.

8. The electronic device according to claim 1, further comprising:
a display,
wherein
the plurality of levels are levels of changes in an image, and
the control signal is a signal for controlling a change in the image displayed by the display.

9. The electronic device according to claim 8, wherein the control signal is a signal for controlling a change in the image while maintaining a display position and/or direction of the image displayed by the display.

10. The electronic device according to claim 1, further comprising:
a memory that stores a plurality of images,
wherein the control signal is a signal for selecting an image to be read out from the memory.

11. The electronic device according to claim 10, wherein
the memory holds the plurality of images and pieces of information having continuity that respectively specify the images in association with each other, and
the control signal is a signal for specifying the information having the continuity based on the specified level, and reading out an image to be displayed from the memory.

12. The electronic device according to claim 1, further comprising:
a transceiver,
wherein the control signal is a signal for controlling a display mode of an image to be displayed on a display device connected to the electronic device via the transceiver.

13. The electronic device according to claim 1, further comprising:
a notifier; and
an alarm time memory that holds an alarm time at which the notifier performs notification,
wherein the control signal is a signal for controlling the alarm time stored in the alarm time memory.

14. The electronic device according to claim 1, further comprising:
a timer that clocks a predetermined period,
wherein the control signal is a signal for setting the predetermined period set in the timer.

15. A control method for an electronic device, the control method comprising:
a determining step of determining, based on first sensing data, whether the electronic device is in a first posture state or not,
a specifying step of specifying a level of a second posture state of the electronic device among a plurality of levels, based on second sensing data that is acquired after determining whether the electronic device is in the first posture state, and
an outputting step of outputting a control signal based on the specified level.

16. A recording medium having a program readable by a computer of an electronic device stored therein, causing the computer to function as:
a determinator that determines, based on first sensing data, whether the electronic device is in a first posture state or not;
a specifier that specifies a level of a second posture state of the electronic device among a plurality of levels, based on second sensing data that is acquired after the determinator determines whether the electronic device is in the first posture state; and
an outputting unit that outputs a control signal based on the specified level.
